(19) United States
(12) Patent Application Publication
(10) Pub. No.: US 2026/0299328 A1
(43) Pub. Date: Oct. 1, 2026

(54) OPTICAL WAVEGUIDE ELEMENT, OPTICAL MODULATOR, AND OPTICAL TRANSMISSION DEVICE

(71) Applicant: SUMITOMO OSAKA CEMENT CO., LTD., Tokyo (JP)

(72) Inventors: Hiroshi Shimada, Tokyo (JP); Kosuke Okahashi, Tokyo (JP); Yu KATAOKA, Tokyo (JP)

(73) Assignee: SUMITOMO OSAKA CEMENT CO., LTD., Tokyo (JP)

(21) Appl. No.: 19/433,017

(22) Filed: Dec. 25, 2025

(30) Foreign Application Priority Data
Mar. 27, 2025 (JP) 2025-053921

(51) Int. Cl. G02F 1/03; G02F 1/21; G02F 1/225

(52) U.S. Cl. CPC G02F 1/0316; G02F 1/212; G02F 1/2255

(57) ABSTRACT

An aspect provides an optical waveguide element in which a signal electrode and two ground electrodes that sandwich the signal electrode from both sides are formed so that a portion thereof extends along an extension direction of an optical waveguide formed on a substrate. The optical waveguide element includes: an electrode bending part, bending an extension direction of the signal electrode and the two ground electrodes; a connection ground electrode, formed below the signal electrode in the electrode bending part and connecting the two ground electrodes; and a buffer layer, formed between the signal electrode and the connection ground electrode.

### CROSS-REFERENCE TO RELATED APPLICATION

This application claims the priority benefit of Japan application serial no. 2025-053921, filed on Mar. 27, 2025. The entirety of the above-mentioned patent application is hereby incorporated by reference herein and made a part of this specification.

### BACKGROUND

### Technical Field

The invention relates to an optical waveguide element, an optical modulator, and an optical transmission device.

### Description of Related Art

In a high-speed/large-capacity optical fiber communication system, an optical modulator incorporating an optical modulation element serving as an optical waveguide element is commonly used. The optical modulation element includes an optical waveguide formed on a substrate and a control electrode that controls light waves propagating through an optical waveguide. As the optical waveguide element that performs an optical modulation operation, a semiconductor optical modulation element using a semiconductor substrate, such as an InP substrate etc., and an LN optical modulation element using LiNbO₃ (hereinafter also referred to as lithium niobate (LN)) as the substrate has been put into practical use.

In the optical waveguide elements that perform the optical modulation operation, an optical waveguide element having an electrode folded structure is provided, as the element becomes miniaturized. In the electrode folded structure of such optical waveguide element, a conventional technology is known that provides an air bridge through wire bonding between ground electrodes in folded parts to prevent conversion to an undesired propagation mode and reduces a transmission loss and a return loss of electrical signals.

### Prior Art Documents

### Patent Documents

Patent Document 1

The specification of Chinese Patent Publication No. 113985629

Patent Document 2

Japanese Patent No. 7504330

Patent Document 3

Japanese Patent Application Laid-open Publication No. 2019-49647

Patent Document 4

Japanese Patent Application Laid-Open Publication No. 2022-38756

Patent Document 5

Japanese Patent No. 5298849

Patent Document 6

Japanese Patent Application Laid-Open Publication No. 2024-524644

However, the above conventional technology needs to secure an electrode area for performing wire bonding, and there is a limit to the miniaturization of the element. Additionally, the light absorption by electrodes may increase, the implementation risks such as short circuits between electrodes due to wire bonding implementation may increase, and the bonding man-hours increase. As a result, it is difficult to miniaturize the element while improving electrical properties.

### SUMMARY

According to an aspect of the disclosure, in an optical waveguide element, a signal electrode and two ground electrodes sandwiching the signal electrode from both sides are formed, so that a portion thereof extends along an extension direction of an optical waveguide formed on a substrate. The optical waveguide element includes: an electrode bending part, bending an extension direction of the signal electrode and the two ground electrodes; a connection ground electrode, in the electrode bending part, formed below the signal electrode and connecting the two ground electrodes; and a buffer layer, formed between the signal electrode and the connection ground electrode.

### BRIEF DESCRIPTION OF THE DRAWINGS

FIG. 1 is a view showing a configuration of an optical modulator according to a first embodiment.

FIG. 2 is a view showing a configuration of an optical modulation element used in the optical modulator shown in FIG. 1.

FIG. 3 is a view showing a folded configuration of electrodes of the optical modulator.

FIG. 4 is a partial detailed view of a portion A in FIG. 3.

FIG. 5 is a cross-sectional view taken along a line V-V of FIG. 3.

FIG. 6 is a view showing a first modification example of a folded configuration of electrodes of an optical modulator.

FIG. 7 is a cross-sectional view taken along a line VII-VII of FIG. 6.

FIG. 8 is a view showing a second modification example of a folded configuration of electrodes of an optical modulator.

FIG. 9 is a cross-sectional view taken along a line IX-IX of FIG. 8.

FIG. 10 is a view showing a third modification example of a folded configuration of electrodes of an optical modulator.

FIG. 11 is a cross-sectional view taken along a line XI-XI of FIG. 10.

FIG. 12 is a view showing a fourth modification example of a folded configuration of electrodes of an optical modulator.

FIG. 13 is a cross-sectional view taken along a line XIII-XIII of FIG. 12.

FIG. 14 is a view showing a fifth modification example of a folded configuration of electrodes of an optical modulator.

FIG. 15 is a cross-sectional view taken along a line XV-XV of FIG. 14.

FIG. 16 is a cross-sectional view taken along a line XVI-XVI of FIG. 14.

FIG. 17 is a view showing a sixth modification example of a folded configuration of an electrode of an optical modulator.

FIG. 18 is a cross-sectional view taken along a line XVIII-XVIII of FIG. 17.

FIG. 19 is a diagram showing a configuration of an optical transmission device according to a second embodiment.

### DESCRIPTION OF THE EMBODIMENTS

According to an aspect of the disclosure, the element can be miniaturized while electrical properties can be improved.

Hereinafter, embodiments according to the disclosure will be described in detail with reference to the drawings. However, detailed descriptions may be omitted more than necessary. For example, detailed descriptions of already well-known matters or redundant descriptions of substantially identical configurations may be omitted.

### First Embodiment

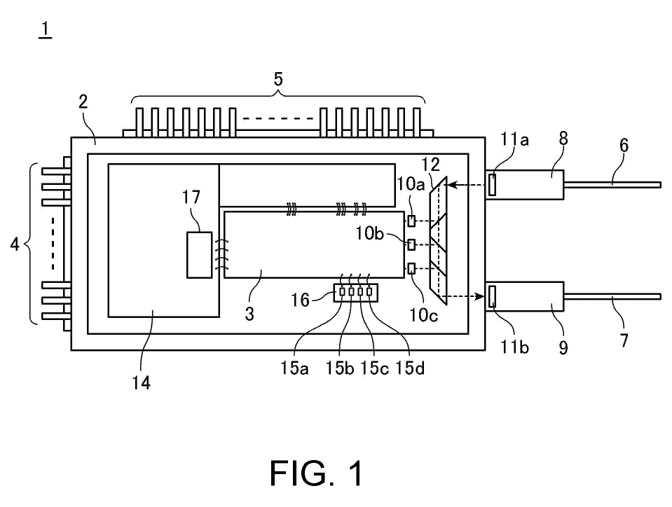

First, a first embodiment according to the disclosure will be described. FIG. 1 is a view showing a configuration of an optical modulator using an optical modulation element that is an optical waveguide element according to the first embodiment.

An optical modulator 1 includes a housing 2 and an optical modulation element 3 accommodated in the housing 2 and generating an optical modulation signal through a traveling wave operation. The optical modulation element 3 has, for example, a nested Mach-Zehnder type coherent communication modulator configuration corresponding to polarization synthesis modulation, and corresponds to a multilevel modulation format, such as DP-QPSK or QAM. The housing 2 conforms to, for example, the industry standard HB-CDM standard ("Implementation Agreement for the High Bandwidth Coherent Driver Modulator (HB-CDM) OIF-HB-CDM-02.0" (Jul. 15, 2021, published by OIF)). The housing 2 is eventually fixed with a cover (not shown) that is a plate body at an opening thereof, and the interior of the housing is hermetically sealed.

The optical modulation element 3 may have a configuration in which a subassembly or a chip is directly applied to a pluggable module. The optical modulation element 3 may have a configuration of being mounted into a transceiver. The optical modulation element 3 may be mounted in co-packaged optics (CPO) or near package optics (NPO). The optical modulation element 3 may be mounted in an IC-TROSA or a coherent optical subassembly (COSA). The optical modulation element 3 may be mounted on a silicon photonics (SiPh) optical circuit.

As a substrate used for the optical modulation element 3, any substrate may be used, as long as it is a material that forms an optical waveguide on the surface of the substrate. Specifically, as a substrate having an electro-optic effect, substrates such as lithium niobate (LN), lithium tantalate (LT), lead lanthanum zirconate titanate (PLZT), or a base material obtained by doping the substrate materials with MgO or the like may be used. It is also possible to form a film through vapor-phase growth of a material such as LN directly on a support substrate such as Si, glass, or sapphire, or with an intermediate layer interposed therebetween. It is also possible to use a substrate in which an electro-optic substrate receives a thin-film process after the electro-optic substrate is bonded to another substrate. Furthermore, a semiconductor substrate, a substrate of an organic material such as an EO polymer, and a quartz substrate used for PLC may also be used. Different types of semiconductor films may be grown on the semiconductor substrate.

The housing 2 is provided with signal pins 4 for inputting high-frequency electrical signals used for modulation of the optical modulation element 3 to a drive circuit 17 mounted on a relay board 14. The housing 2 is also provided with signal pins 5 for inputting electrical signals used for adjusting the operating point of the optical modulation element 3, inputting the power for the operation of the drive circuit 17, and inputting and outputting the control signals necessary for operating the drive circuit 17.

The optical modulator 1 also includes, on the same plane of the housing 2, an input optical fiber 6 for inputting light into the housing 2, and an output optical fiber 7 for guiding light modulated by the optical modulation element 3 to the outside of the housing 2. The optical modulator 1 also includes a polarization synthesizing element 12 having both a beam shift function and a polarization synthesis function.

The input optical fiber 6 and the output optical fiber 7 are respectively fixed to the housing 2 via supports 8 and 9, which are fixing members. The light input from the input optical fiber 6 is collimated by a lens 11a disposed within the support 8, then passes through the polarization synthesizing element 12, and is input to the optical modulation element 3 via a lens 10a. However, this is merely an example, and the input of light to the optical modulation element 3 may be performed according to conventional technology, for example, by introducing the input optical fiber 6 into the housing 2 via the support 8 and connecting the end surface of the introduced input optical fiber 6 to the end surface of an optical substrate 30 (described later) of the optical modulation element 3.

Two modulated lights output from the optical modulation element 3 are respectively collimated by lenses 10b and 10c, and then synthesized into one beam by the polarization synthesis function of the polarization synthesizing element 12. The synthesized beam is focused by a lens 11b disposed within the support 9 and coupled to the output optical fiber 7.

Within the housing 2 of the optical modulator 1, a relay board 14 and a terminator 16 including four terminal resistors 15a, 15b, 15c, and 15d having predetermined impedance are also disposed. Hereinafter, the terminal resistors 15a, 15b, 15c, and 15d may be collectively referred to as terminal resistors 15. The electrical connection between the optical modulation element 3 and the terminal resistors 15 of the terminator 16 is performed by, for example, wire bonding.

The relay board 14 includes a drive circuit 17. The drive circuit 17 amplifies a high-frequency electrical signal input from the signal pin 4 and outputs a drive signal, which is a high-frequency electrical signal for causing the optical modulation element 3 to perform a modulation operation. The relay board 14 also relays electrical signals for operating point adjustment input from the signal pin 5, power supply, and control signals to the optical modulation element 3. Conductor patterns of the relay board 14 are respectively connected to pads (not shown) forming an end of the electrode of the optical modulation element 3 by, for example, wire bonding. Although the relay board 14 is illustrated as a single substrate in FIG. 1, it may also be configured by being divided into multiple substrates as necessary. The drive circuit 17 may also be mounted on the relay board 14 as shown in FIG. 1, or may be disposed between the relay board 14 and the optical modulation element 3. Instead of the signal pin 4, an interface used for inputting high-frequency electrical signals may be a flexible substrate (FPC) disposed outside the housing 2.

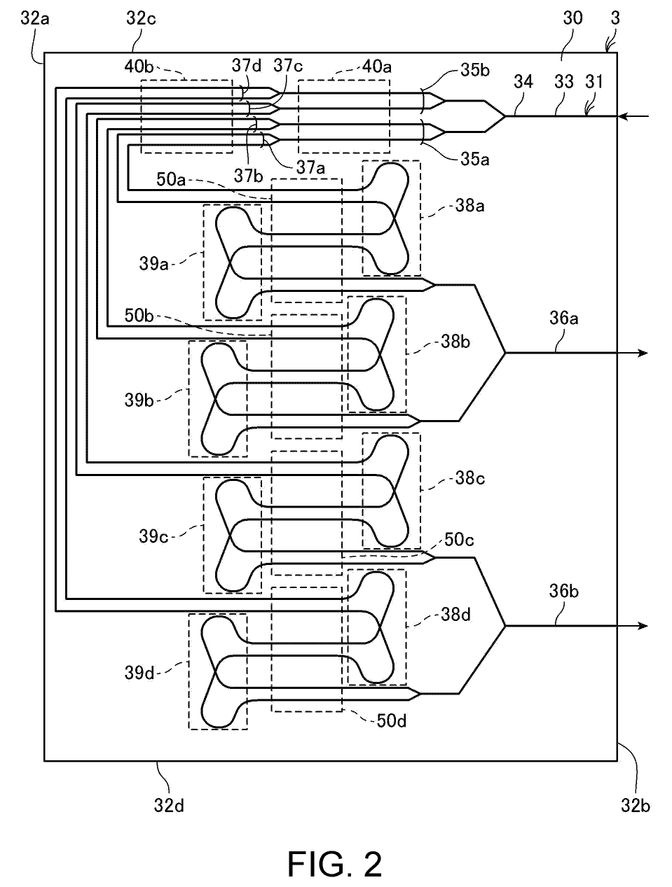

FIG. 2 is a view showing the configuration of the optical modulation element 3 used in the optical modulator 1 shown in FIG. 1. As shown in FIG. 2, the optical modulation element 3 is a DP-QPSK modulator or the like.

The optical modulation element 3 is configured with an optical waveguide 31 formed on a main surface (the surface shown in FIG. 2) of the optical substrate 30, and performs coherent multilevel modulation exceeding, for example, 100 GBaud. The optical substrate 30 is, for example, an X-cut LN substrate having an electro-optic effect that is processed to a thickness of 20 μm or less (for example, 2 μm) and formed into a thin film. The optical waveguide 31 is a convex optical waveguide (for example, a rib-type optical waveguide or a ridge-type optical waveguide) configured with a convex portion extending in a strip shape formed on the surface of the thin-film optical substrate 30.

The optical substrate 30 is, for example, rectangular, and has two edges 32a and 32b on the left and right sides in the drawing that extend in the up-down direction in the drawing and face each other, and edges 32c and 32d on the upper and lower sides in the drawing that extend in the left-right direction in the drawing and face each other.

The optical waveguide 31 includes an input waveguide 33 that receives input light (an arrow pointing leftward in the drawing) from the input optical fiber 6 at the upper side in the drawing of the edge 32b on the right side in the drawing of the optical substrate 30, and a branching waveguide 34 that branches the input light into two lights having the same light quantity. The optical waveguide 31 also includes two modulation parts that modulate the respective lights branched by the branching waveguide 34, namely so-called nested Mach-Zehnder optical waveguides 35a and 35b.

The nested Mach-Zehnder optical waveguides 35a and 35b each include two Mach-Zehnder optical waveguides 37a and 37b, and Mach-Zehnder optical waveguides 37c and 37d, respectively provided in two waveguide portions forming a pair of parallel waveguides. Hereinafter, the Mach-Zehnder optical waveguides 37a, 37b, 37c, and 37dmay be collectively referred to as Mach-Zehnder optical waveguides 37. According to conventional technology, each Mach-Zehnder optical waveguide 37 includes two parallel waveguides.

In the nested Mach-Zehnder optical waveguides 35a and 35b, the light propagation direction is folded back by 180 degrees, and after the modulation operation is performed in the Mach-Zehnder optical waveguide 37, the light is output from the edge 32b of the optical substrate 30 toward the right side in the drawing through output waveguides 36a and 36b.

The nested Mach-Zehnder optical waveguides 35a and 35b have a first bias electrode part 40a where bias electrodes for adjusting operating points are formed. The Mach-Zehnder optical waveguides 37 have a second bias electrode part 40b where bias electrodes for adjusting the respective operating points of the four Mach-Zehnder optical waveguides 37a, 37b, 37c, and 37d are formed.

Each of the four Mach-Zehnder optical waveguides 37a, 37b, 37c, and 37d has first folding regions 38a, 38b, 38c, and 38d and second folding regions 39a, 39b, 39c, and 39d where the light propagation direction is folded back by 180 degrees, and RF electrode parts 50a, 50b, 50c, and 50d. Hereinafter, the first folding regions 38a, 38b, 38c, and 38d may be collectively referred to as the first folding regions 38. The second folding regions 39a, 39b, 39c, and 39dmay be collectively referred to as the second folding regions 39. The RF electrode parts 50a, 50b, 50c, and 50d may be collectively referred to as the RF electrode parts 50.

The Mach-Zehnder optical waveguides 37 are connected to the output waveguides 36a and 36b after the light propagation direction is folded back by 180 degrees (from left to right in the drawing) in the first folding region 38 and then folded back by 180 degrees (from right to left in the drawing) in the second folding region 39.

The RF electrode parts 50 are located between the first folding regions 38 and the second folding regions 39, and modulate light waves propagating through the Mach-Zehnder optical waveguides 37 according to the high-frequency electrical signals output from the drive circuit 17. Specifically, in the RF electrode parts 50, signal electrodes that cause the modulation operation in the respective four Mach-Zehnder optical waveguides 37a, 37b, 37c, and 37d are formed to extend along the extension direction between two parallel waveguides. Also, for each of the signal electrodes, according to conventional technology, two ground electrodes are formed on the main surface of the optical substrate 30 to sandwich the signal electrode from positions separated by a constant distance and extend along the extension direction of the two parallel waveguides.

Therefore, in the RF electrode part 50, each of the signal electrodes constitutes a distributed constant line having a predetermined impedance together with two ground electrodes. As a result, four drive signals output from the drive circuit 17 are respectively input to the signal electrodes corresponding to the four Mach-Zehnder optical waveguides 37a, 37b, 37c, and 37d, and propagate through each of the signal electrodes as traveling waves. The drive signals propagating through the signal electrodes modulate the light waves propagating through the corresponding Mach-Zehnder optical waveguides 37, and are then terminated by the corresponding terminal resistors 15.

The signal electrode that causes the Mach-Zehnder optical waveguide 37 to perform the modulation operation and the two ground electrodes corresponding to the signal electrode are folded back in accordance with the folding of the Mach-Zehnder optical waveguide 37 so as to extend along the extension direction of the Mach-Zehnder optical waveguide 37 in the RF electrode part 50.

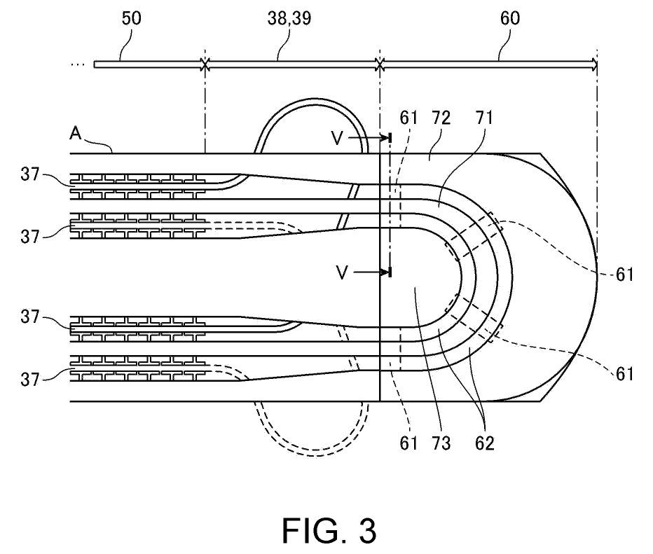

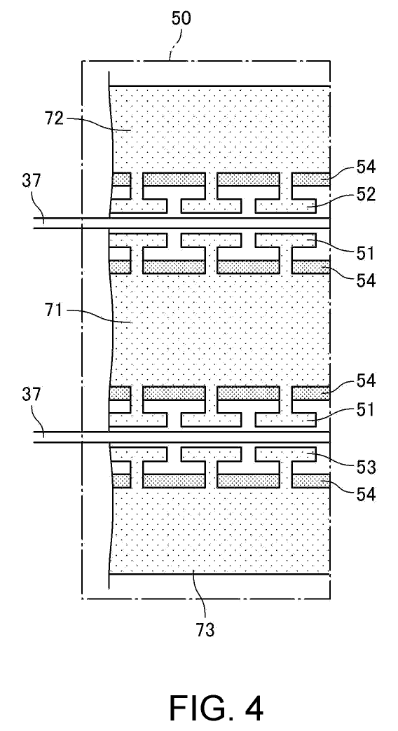

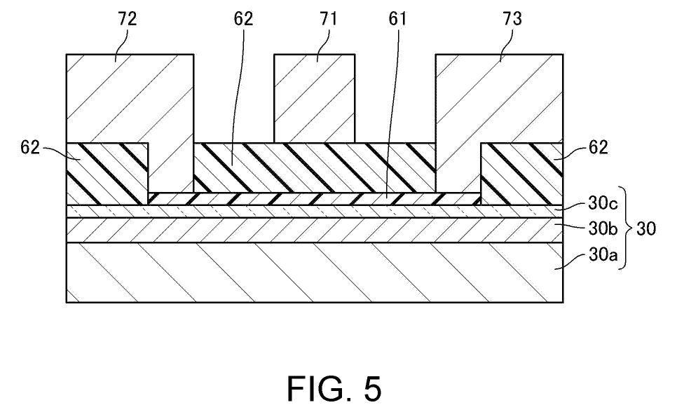

FIG. 3 is a view showing a folded configuration of electrodes of the optical modulator 1. More specifically, FIG. 3 illustrates a folded configuration of a signal electrode related to the modulation operation of the RF electrode part 50 and two ground electrodes. FIG. 4 is a partial detailed view of a portion A in FIG. 3. FIG. 5 is a cross-sectional view taken along a line V-V in FIG. 3.

As shown in FIG. 3, in the signal electrode 71 that extends from the RF electrode part 50 beyond the first folding region 38 and the second folding region 39 and the two ground electrodes 72 and 73 that sandwich the signal electrode 71 from positions separated by a constant distance in parallel, the extension direction is inverted by 180 degrees in a U-shape in an electrode bending part 60.

In the first folding region 38 and the second folding region 39, the distance from the folding start position of the Mach-Zehnder optical waveguide 37 in the vicinity of the end of the RF electrode part 50 to the outermost position of the Mach-Zehnder optical waveguide 37 that expands due to folding is 500 μm or less. The electrode bending part 60 is disposed further outside without overlapping with the outermost position of the Mach-Zehnder optical waveguide 37.

FIG. 4 is a partial detailed view of a portion A in FIG. 3, and is a diagram showing an electrode configuration of the Mach-Zehnder optical waveguide 37 in the RF electrode part 50. In FIG. 4, light is incident from the left side of the drawing and exits to the right side of the drawing.

The optical modulation element 3, which is an optical waveguide element, includes the signal electrode 71 that controls light waves propagating through the Mach-Zehnder optical waveguide 37 and the ground electrodes 72 and 73 in the RF electrode part 50. The signal electrode 71 is disposed between two parallel waveguides in the Mach-Zehnder optical waveguide 37 along the extension direction of the waveguides. The two ground electrodes 72 and 73 are respectively disposed at positions facing the signal electrode 71 by sandwiching the two parallel waveguides in the Mach-Zehnder optical waveguide 37 along the extension direction of the waveguides.

The signal electrode 71 and the ground electrodes 72 and 73 are formed by, for example, gold (Au), and for improving the adhesion with the optical substrate 30, for example, chromium (Cr), titanium (Ti), nickel (Ni), niobium (Nb), etc., may be used as base metals.

The signal electrode 71 includes multiple segment electrodes 51 that are disposed closer to the Mach-Zehnder optical waveguide 37 than the signal electrode 71 and are divided along the extension direction of the Mach-Zehnder optical waveguide 37. The ground electrode 72 includes multiple segment electrodes 52 that are disposed closer to the Mach-Zehnder optical waveguide 37 than the ground electrode 72 and are divided along the extension direction of the Mach-Zehnder optical waveguide 37. The ground electrode 73 includes multiple segment electrodes 53 that are disposed closer to the Mach-Zehnder optical waveguide 37 than the ground electrode 73 and are divided along the extension direction of the Mach-Zehnder optical waveguide 37. A low dielectric layer 54 having a relative permittivity lower than that of the optical substrate 30 is disposed between the lower portion of each of the signal electrode 71 and the ground electrodes 72 and 73 and the optical substrate 30. The relative permittivity of the low dielectric layer 54 is preferably 1 or more and 10 or less. The low dielectric layer 54 may be formed by, for example, SiO₂, low dielectric resin such as benzocyclobutene (BCB), silicon nitride, or the like.

In the optical modulation element 3, an electric field is applied to the Mach-Zehnder optical waveguide 37 by the segment electrodes 51 and 52 or the segment electrodes 51 and 53 provided close to the Mach-Zehnder optical waveguide 37, and the optical modulation operation is performed by causing an electro-optic effect to act on the Mach-Zehnder optical waveguide 37. That is, the segment electrodes 51, 52, and 53 are an example of working electrodes.

The signal electrode 71 extending along the Mach-Zehnder optical waveguide 37 and the ground electrodes 72 and 73 are formed in a U-shape at the electrode bending part 60 further outside than the first folding region 38 or the second folding region 39 where the Mach-Zehnder optical waveguide 37 is folded, and the extension direction of the signal electrode 71 and the ground electrodes 72 and 73 is folded back. In this way, the signal electrode 71 and the ground electrodes 72 and 73 are disposed to follow the extension direction of the Mach-Zehnder optical waveguide 37 after folding by the first folding region 38 or the second folding region 39. The configuration of the working electrode described above exemplifies a single configuration, but may be a differential configuration.

In the electrode bending part 60, a connection ground electrode 61 that connects the two ground electrodes 72 and 73 is formed below the signal electrode 71. For example, multiple connection ground electrodes 61 are formed at equal intervals in the extension direction of the two ground electrodes 72 and 73, as shown in the illustrated example.

In the optical modulation element 3, the two ground electrodes 72 and 73 are connected by the connection ground electrode 61 at the electrode bending part 60. Accordingly, the conversion to an unnecessary propagation mode is suppressed at the electrode bending part 60, and electrical properties are improved. Moreover, in the case where multiple connection ground electrodes 61 are formed as shown in the illustrated example, phase shift can be mitigated more reliably.

As shown in FIG. 5, the optical substrate 30 has a configuration in which a bottom buffer layer 30b serving as a base is formed on a reinforcement substrate 30a, and an LN layer 30c is formed on the bottom buffer layer 30b.

The reinforcement substrate 30a is a base substrate formed by Si, glass, quartz, fused silica, synthetic silica, alkali glass, alkali-free glass, lead glass, borosilicate glass, soda glass, sapphire, alumina, or the like.

The bottom buffer layer 30b is a thin film formed of a dielectric material having a lower refractive index than the LN layer 30c and high transparency. The dielectric material used for the bottom buffer layer 30b is, for example, SiO₂, Al₂O₃, SiN, MgF₂, La₂O₃, ZnO, HfO₂, MgO, CaF₂, Y₂O₃, or the like, and oxides, fluorides, and nitrides of metal elements of Groups 1 to 17 of the periodic table can be applied.

The LN layer 30c is a layer in which the rib-type optical waveguide 31 is formed, has a thickness of 1.0 μm or less, and is bonded to the reinforcement substrate 30a via the bottom buffer layer 30b. The LN layer 30c is, for example, a single crystal material such as LN or LT having an electro-optic effect, and may be doped with MgO or the like.

The connection ground electrode 61 is formed on this LN layer 30c. That is, the connection ground electrode 61 and the segment electrodes 51, 52, 53 formed so as to sandwich the rib-shaped Mach-Zehnder optical waveguide 37 in the RF electrode part 50 are formed in the same layer. The thickness of the connection ground electrode 61 and the segment electrodes 51, 52, 53 formed at this time is 1 μm or less. Moreover, the connection ground electrode 61 and the segment electrodes 51, 52, 53 are formed of the same metal as the signal electrode 71 and the ground electrodes 72, 73 (for example, gold (Au)).

For the formation of the connection ground electrode 61, for example, EB lithography using an electron beam (EB) exposure apparatus can be applied. In the case where the connection ground electrode 61 is formed by EB lithography, the line width of the connection ground electrode 61 can be 2 μm, which is a general minimum value in EB lithography. Since a general mask line width used in photolithography or the like is 4 μm and a general wire width in wire bonding is 20 μm, in the case where the connection ground electrode 61 is formed by EB lithography, the line width of the connection ground electrode 61 can be shortened to 20 μm or less, and can be further reduced to 4 μm. In this manner, in the optical modulation element 3, by making the line width of the connection ground electrode 61 narrow, the reflection points related to impedance matching can be reduced, and impedance mismatch can be mitigated.

After forming the layer related to the connection ground electrode 61, an upper buffer layer 62 is formed on the LN layer 30c with a predetermined film thickness. The upper buffer layer 62 is a thin film formed of a dielectric material having a lower refractive index than the LN layer 30c and high transparency. The dielectric material used for the upper buffer layer 62 is, for example, SiO₂, Al₂O₃, SiN, MgF₂, La₂O₃, ZnO, HfO₂, MgO, CaF₂, Y₂O₃, or the like, and oxides, fluorides, and nitrides of metal elements of groups 1 to 17 of the periodic table can be applied. Moreover, the upper buffer layer 62 is a permanent resist, and a photoresist using a thermosetting resin as a material can also be applied.

Next, the signal electrode 71 and the ground electrodes 72, 73 are formed on the upper buffer layer 62 through a process such as photolithography. The connection ground electrode 61 and the ground electrodes 72, 73 are joined vertically so as to penetrate through the upper buffer layer 62. Moreover, the connection ground electrode 61 and the signal electrode 71 are not joined vertically, and are formed so as to sandwich the upper buffer layer 62 between the connection ground electrode 61 and the signal electrode 71.

In this manner, in the electrode bending part 60, the two ground electrodes 72, 73 are connected via the connection ground electrode 61 formed in a layer below the signal electrode 71 and the ground electrodes 72, 73. Therefore, the ground electrodes 72, 73 in the electrode bending part 60 can be connected without performing wire bonding. That is, the number of steps of wire bonding can be reduced. Moreover, since there is no need to secure a gap between the electrodes for performing wire bonding, the optical modulation element 3 can be miniaturized while electrical properties can be improved. Additionally, connecting the two ground electrodes 72, 73 via the connection ground electrode 61 formed in the lower layer is easier to perform than forming a bridge on the two ground electrodes 72, 73 by wire bonding, and since the connection ground electrode 61 is formed in the lower layer, it is less likely to be damaged. For example, in conventional wire bonding, a stress is applied to the electrodes and the substrate below the electrodes during bonding, and a risk of damage arises. Comparatively, in the disclosure, the connection ground electrode 61 is formed below the signal electrode 71 and connected on the lower side of the electrode, so no stress is applied, and even in the case where the electrode of the second stage is thin (for example, 10 μm or less), connection can be achieved without the risk of damage.

### First Modification Example

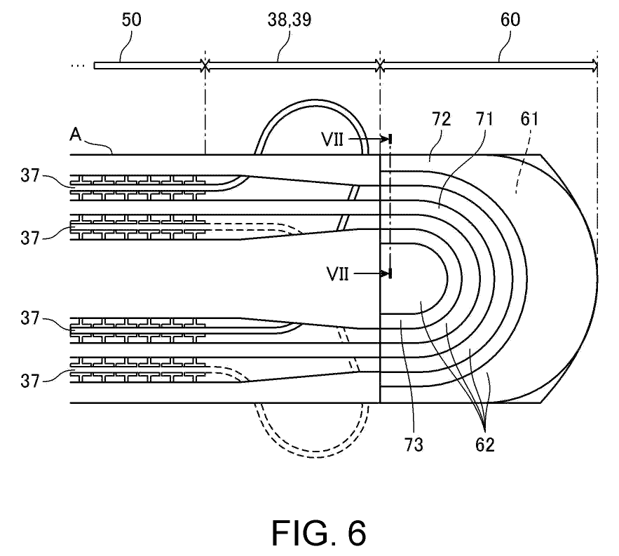

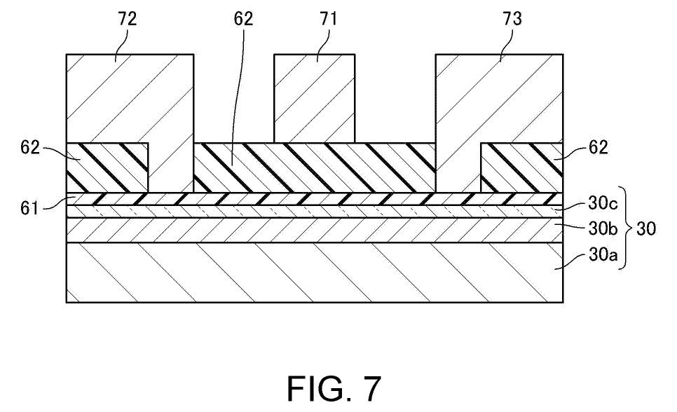

Here, a first modification example of the folded configuration of the electrode of the optical modulator 1 will be described. FIG. 6 is a view showing the first modification example of the folded configuration of the electrodes of the optical modulator 1. FIG. 7 is a cross-sectional view taken along a line VII-VII of FIG. 6.

As shown in FIG. 6 and FIG. 7, in the first modification example, the connection ground electrode 61 is formed over the entire surface of the electrode bending part 60. In this manner, in the case where the connection ground electrode 61 is formed over the entire surface of the electrode bending part 60, the ground area where the ground electrodes 72, 73 are connected to the connection ground electrode 61 increases, and the processing stability is improved.

### Second Modification Example

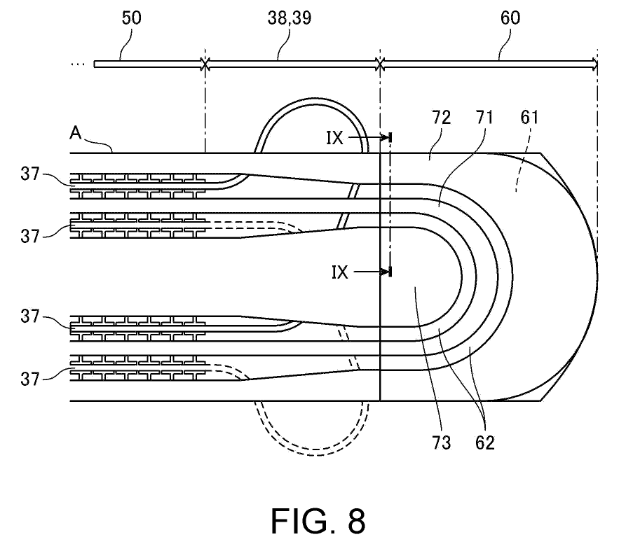

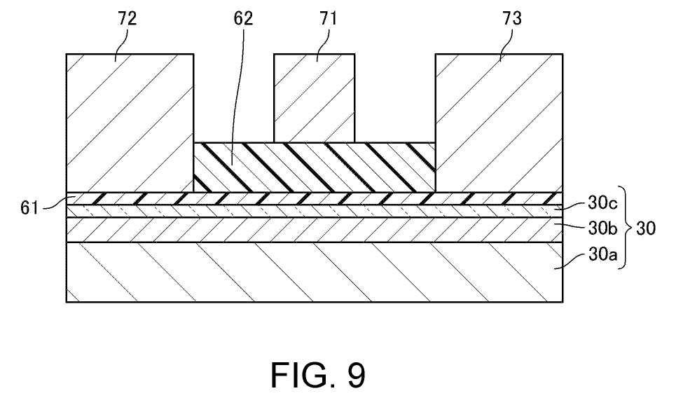

Here, a second modification example of the folded configuration of the electrodes of the optical modulator 1 will be described. FIG. 8 is a view showing the second modification example of the folded configuration of the electrodes of the optical modulator 1. FIG. 9 is a cross-sectional view taken along a line IX-IX of FIG. 8.

As shown in FIG. 8 and FIG. 9, in the second modification example, the configuration is not a configuration in which the upper buffer layer 62 is not sandwiched between the ground electrodes 72, 73 and the connection ground electrode 61. In this manner, in the second modification example, a connection failure between the connection ground electrode 61 and the ground electrodes 72, 73 can be suppressed, and the processing stability can be further improved, as compared to the first modification example described above.

### Third Modification Example

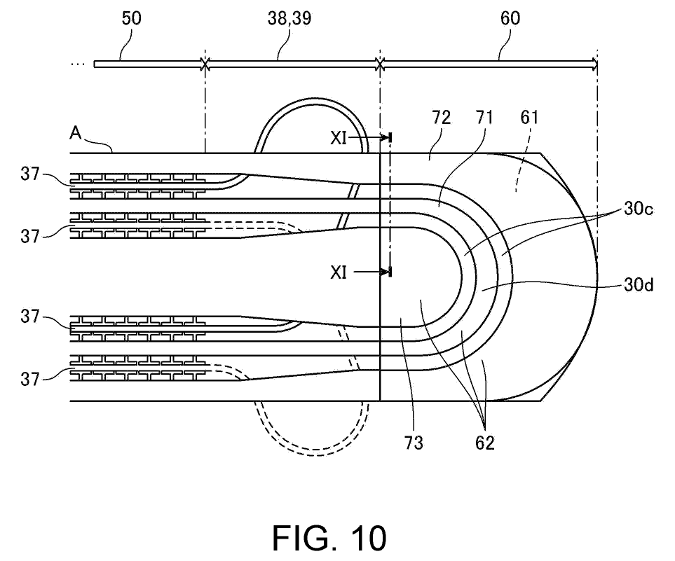

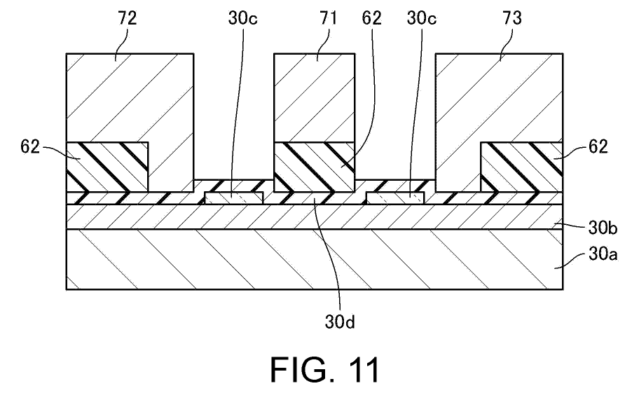

Here, a third modification example of the folded configuration of the electrodes of the optical modulator 1 will be described. FIG. 10 is a view showing the third modification example of the folded configuration of the electrodes of the optical modulator 1. FIG. 11 is a cross-sectional view taken along a line XI-XI of FIG. 10.

As shown in FIG. 10 and FIG. 11, in the third modification example, in the electrode bending part 60, the LN layer 30c having the groove 30d provided at a position corresponding to the lower portion of the signal electrode 71 is formed. In this manner, by digging the groove 30din the LN layer 30c, a loss of the high frequency signal propagating through the signal electrode 71 can be reduced.

### Fourth Modification Example

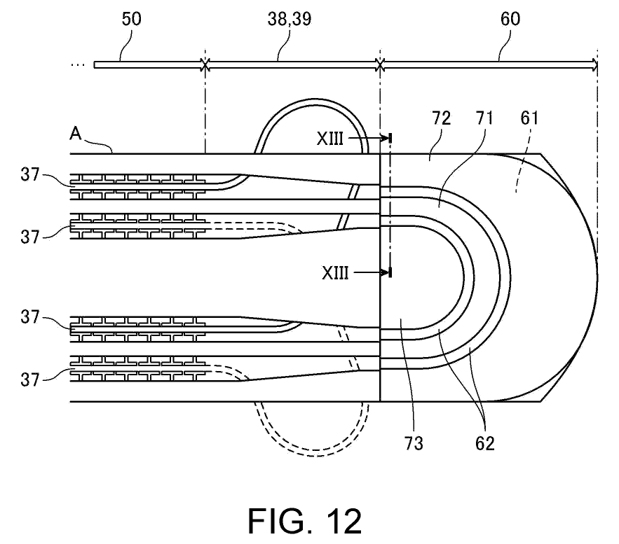

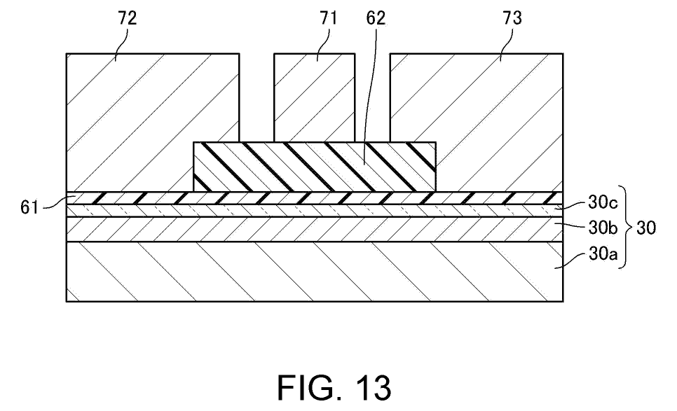

Here, a fourth modification example of the folded configuration of the electrodes of the optical modulator 1 will be described. FIG. 12 is a view showing a fourth modification example of the folded configuration of the electrodes of the optical modulator 1. FIG. 13 is a cross-sectional view taken along a line XIII-XIII of FIG. 12.

As shown in FIG. 12 and FIG. 13, in the fourth modification example, the configuration covers the upper portions of both end portions of the upper buffer layer 62 formed between the ground electrodes 72, 73 by covering portions of the ground electrodes 72, 73 from above. By forming the ground electrodes 72, 73 in this manner, peeling of the upper buffer layer 62 from the upper surface of the optical modulation element 3 can be suppressed.

### Fifth Modification Example

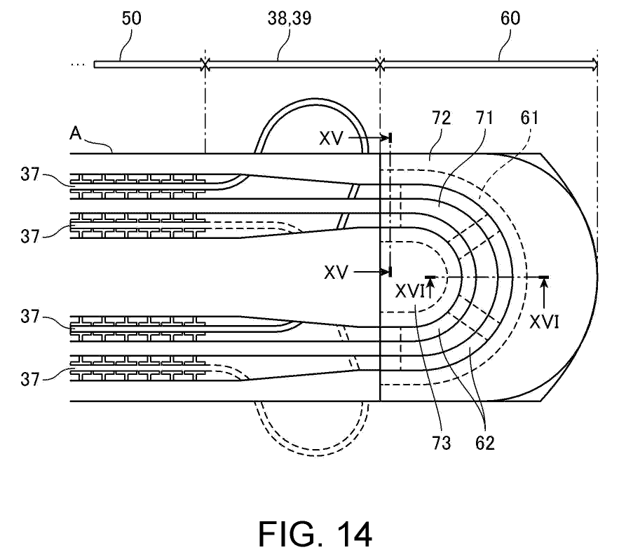

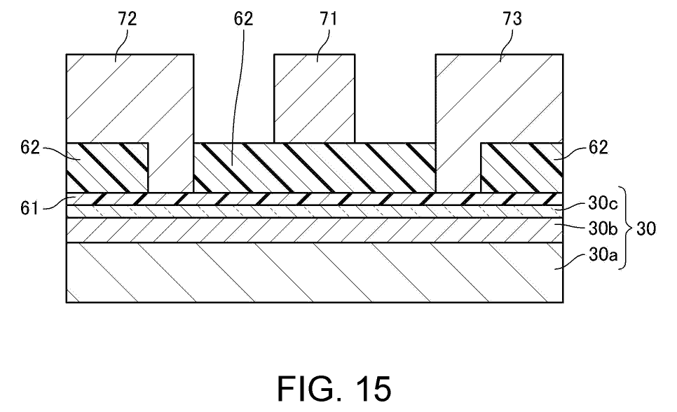

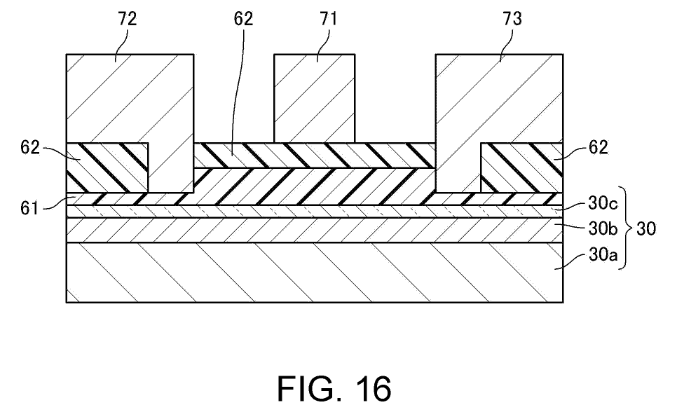

Here, a fifth modification example of the folded configuration of the electrodes of the optical modulator 1 will be described. FIG. 14 is a view showing the fifth modification example of the folded configuration of the electrodes of the optical modulator 1. FIG. 15 is a cross-sectional view taken along a line XV-XV of FIG. 14. FIG. 16 is a cross-sectional view taken along a line XVI-XVI of FIG. 14.

As shown in FIG. 14, FIG. 15, and FIG. 16, in the fifth modification example, the connection ground electrode 61 is formed in an arc shape along the folding of the ground electrodes 72, 73. Also, in the fifth modification example, the connection ground electrodes 61 that connect the ground electrodes 72, 73 are formed radially at equal intervals so as to be orthogonal to the extension direction of the signal electrode 71.

When the electrode width of the connection ground electrode 61 that is orthogonal to the lower layer of the signal electrode 71 increases, the impedance decreases and causes impedance mismatch. Therefore, in the fifth modification example, the connection ground electrodes 61 that connect the ground electrodes 72, 73 are arranged radially at equal intervals, thereby enabling the electrode width of the connection ground electrode 61 in the lower layer of the signal electrode 71 to be shortened and impedance mismatch to be suppressed. Also, since the connection ground electrode 61 is formed in a U-shape along the folding of the ground electrodes 72, 73, the ground area where the ground electrodes 72, 73 are connected to the connection ground electrode 61 increases, and the processing stability is improved.

### Sixth Modification Example

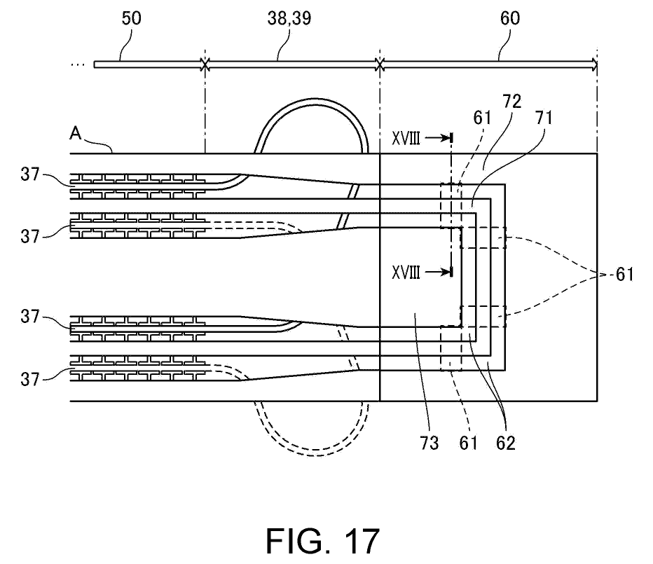

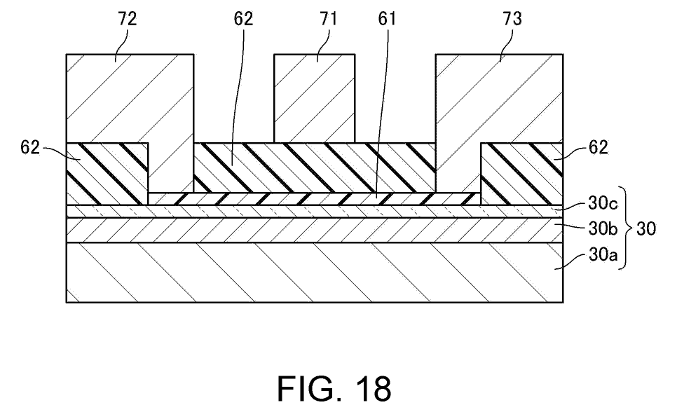

Here, a sixth modification example of the folded configuration of the electrodes of the optical modulator 1 will be described. FIG. 17 is a view showing the sixth modification example of the folded configuration of the electrodes of the optical modulator 1. FIG. 18 is a cross-sectional view taken along a line XVIII-XVIII of FIG. 17.

As shown in FIG. 17 and FIG. 18, in the sixth modification example, unlike the fifth modification example, the connection ground electrode 61 is not formed in an arc shape along the folding of the ground electrodes 72, 73, but is formed in a rectangular shape. The connection ground electrode 61 may also be formed in such rectangular shape.

### Second Embodiment

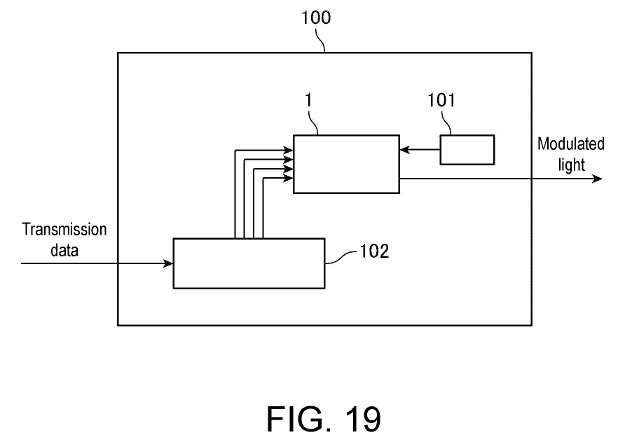

Next, a second embodiment of the disclosure will be described. The embodiment is an optical transmission device provided with the optical modulator 1 according to the first embodiment or the modification examples thereof. FIG. 19 is a diagram showing a configuration of the optical transmission device according to the second embodiment.

As shown in FIG. 19, an optical transmission device 100 includes the optical modulator 1, a light source 101, and a modulation signal generation part 102. The modulation signal generation part 102 is an electronic circuit that generates a high frequency signal (modulation signal) for causing the optical modulator 1 to perform the modulation operation. The modulation signal generation part 102 generates, for example, four modulation signals to be input to the optical modulation element 3 included in the optical modulator 1 based on the transmission data provided from the outside, and inputs the modulation signals to the signal pins 4 of the optical modulator 1. In this way, the optical modulator 1 modulates the light from the light source 101 incident from the input optical fiber 6, and outputs the modulated light via the output optical fiber 7.

In the optical transmission device 100 having the configuration, since the optical modulator 1 described above is used, the element can be miniaturized, while electrical properties can be improved.

### Other Embodiments

Various modification examples in the first and second embodiments described above can be arbitrarily combined to constitute one optical waveguide element (for example, the optical modulation element 3). For example, these modification examples can be applied in combination in all other modification examples.

Also, the optical waveguide element in the disclosure is not limited to the optical modulation element 3 that performs the optical modulation operation by using a nested Mach-Zehnder optical waveguide, but may be various optical waveguide elements that realize arbitrary functions using optical waveguides formed in arbitrary patterns. For example, the optical waveguide element may be configured with a single Mach-Zehnder optical waveguide (for example, a configuration in which single Mach-Zehnder optical waveguides are arranged in parallel), or may realize functions such as optical switching, with a configuration of including directional coupler type waveguides and/or Y-branch waveguides, etc.

Also, the electrode structure of the optical waveguide element in the disclosure is a normal coplanar structure in which both the signal electrode and ground electrode in the working section segments, folded sections, etc., are formed on the same plane, but other configurations (for example, both are segments, or both are coplanar) may be used. Regarding the electrode structure of the optical waveguide element in the disclosure, since the folding of the optical waveguide is arranged ahead of the folding of the electrode, the configuration has a longer electrical line (electrode length) than the optical waveguide. Therefore, considering that the working section generally achieves velocity matching with the optical waveguide, the effective refractive index of the high frequency signal in the electrode becomes lower than the effective refractive index (group refractive index) of light in the optical waveguide.

The invention is not limited to the configuration of the above embodiment and its alternative configurations, and can be implemented in various aspects within a range that does not depart from the gist thereof.

### Configurations supported by the Embodiments

The embodiments and modification examples support the following configurations.

(Configuration 1) In an optical waveguide element, a signal electrode and two ground electrodes sandwiching the signal electrode from both sides are formed, so that a portion thereof extends along an extension direction of an optical waveguide formed on a substrate. The optical waveguide element includes: an electrode bending part, bending an extension direction of the signal electrode and the two ground electrodes; a connection ground electrode, in the electrode bending part, formed below the signal electrode and connecting the two ground electrodes; and a buffer layer, formed between the signal electrode and the connection ground electrode.

Accordingly, the connection between ground electrodes at the location where the electrode is folded can be performed without performing wire bonding. Therefore, since there is no need to secure a gap between electrodes for performing wire bonding, the element can be miniaturized while electrical properties can be improved.

(Configuration 2) In the optical waveguide element according to Configuration 1, the electrode bending part is formed in a region where the optical waveguide is not formed on the substrate.

Accordingly, the electrode can be bent while avoiding the influence on the optical waveguide.

(Configuration 3) In the optical waveguide element according to Configuration 2, the electrode bending part is formed in a region outside a region where the optical waveguide is bent.

Accordingly, the electrode can be bent while the optical path length of the optical waveguide can be shortened.

(Configuration 4) In the optical waveguide element according to any one of Configurations 1 to 3, the connection ground electrode is formed on a layer where the optical waveguide is formed.

Accordingly, the optical waveguide can be formed in a layer between the substrate and the connection ground electrode.

(Configuration 5) In the optical waveguide element according to any one of Configurations 1 to 4, a plurality of the connection ground electrodes are formed in the electrode bending part.

Accordingly, phase shift can be more reliably mitigated by the connection ground electrodes.

(Configuration 6) In the optical waveguide element according to any one of Configurations 1 to 5, on the substrate, the signal electrode and the two ground electrodes have a working electrode that applies an electro-optic effect to the optical waveguide in a region along the optical waveguide, and the connection ground electrode and the working electrode are formed in a same layer on the substrate.

Accordingly, the connection ground electrode and the working electrode can be formed in the same process.

(Configuration 7) In the optical waveguide element according to Configuration 6, the connection ground electrode and the working electrode have a thickness of 1 μm or less.

Accordingly, the thickness of the connection ground electrode and the working electrode can be made into a thin film of 1 μm or less.

(Configuration 8) In the optical waveguide element according to any one of Configurations 1 to 7, the electrode bending part reverses the extension direction of the signal electrode and the two ground electrodes by 180 degrees in a U-shape.

Accordingly, the extension direction of the signal electrode and the two ground electrodes can be folded back in a U-shape and reversed by 180 degrees.

(Configuration 9) In the optical waveguide element according to any one of Configurations 1 to 8, the connection ground electrode has an electrode width of 20 μm or less.

Accordingly, the width can be reduced to 20 μm or less, which is a general line width for wire bonding, and impedance mismatch can be reduced.

(Configuration 10) An optical modulator includes: the optical waveguide element according to any one of Configurations 1 to 9, which is an optical modulation element; a housing, accommodating the optical waveguide element; an optical fiber, inputting light to the optical waveguide element; and an optical fiber, guiding light output by the optical waveguide element to outside of the housing.

Accordingly, an optical modulator with improved electrical properties and a miniaturized element can be realized.

(Configuration 11) An optical transmission device includes: the optical modulator according to Configuration 10; and an electronic circuit, generating an electrical signal for causing the optical waveguide element to perform an optical modulation operation.

Accordingly, an optical transmission device with improved electrical properties and a miniaturized element can be realized.

What is claimed is:

1. An optical waveguide element, in which a signal electrode and two ground electrodes sandwiching the signal electrode from both sides are formed, such that a portion thereof extends along an extension direction of an optical waveguide formed on a substrate, the optical waveguide element comprising:
an electrode bending part, bending an extension direction of the signal electrode and the two ground electrodes;
a connection ground electrode, in the electrode bending part, formed below the signal electrode and connecting the two ground electrodes; and
a buffer layer, formed between the signal electrode and the connection ground electrode.

2. The optical waveguide element as claimed in claim 1, wherein the electrode bending part is formed in a region where the optical waveguide is not formed on the substrate.

3. The optical waveguide element as claimed in claim 2, wherein the electrode bending part is formed in a region outside a region where the optical waveguide is bent.

4. The optical waveguide element as claimed in claim 1, wherein the connection ground electrode is formed on a layer where the optical waveguide is formed.

5. The optical waveguide element as claimed in claim 1, wherein a plurality of the connection ground electrodes are formed in the electrode bending part.

6. The optical waveguide element as claimed in claim 1, wherein on the substrate, the signal electrode and the two ground electrodes have a working electrode that applies an electro-optic effect to the optical waveguide in a region along the optical waveguide, and
the connection ground electrode and the working electrode are formed in a same layer on the substrate.

7. The optical waveguide element as claimed in claim 6, wherein the connection ground electrode and the working electrode have a thickness of 1 μm or less.

8. The optical waveguide element as claimed in claim 1, wherein the electrode bending part reverses an extension direction of the signal electrode and the two ground electrodes by 180 degrees in a U-shape.

9. The optical waveguide element as claimed in claim 1, wherein the connection ground electrode has an electrode width of 20 μm or less.

10. An optical modulator, comprising:
the optical waveguide element as claimed in claim 1, which is an optical modulation element;
a housing, accommodating the optical waveguide element;
an optical fiber, inputting light to the optical waveguide element; and
an optical fiber, guiding light output by the optical waveguide element to outside of the housing.

11. An optical transmission device, comprising:
the optical modulator as claimed in claim 10; and
an electronic circuit, generating an electrical signal for causing the optical waveguide element to perform an optical modulation operation.
